(19) United States
(12) Patent Application Publication
(10) Pub. No.: US 2026/0231145 A1
(43) Pub. Date: Aug. 6, 2026

(54) METHODS, COMMUNICATIONS DEVICES, AND INFRASTRUCTURE EQUIPMENT

(71) Applicant: Sony Group Corporation, Tokyo (JP)

(72) Inventors: Yassin Aden AWAD, Basingstoke (GB); Shin Horng WONG, Basingstoke (GB); Basuki PRIYANTO, Basingstoke (GB)

(73) Assignee: Sony Group Corporation, Tokyo (JP)

(21) Appl. No.: 19/151,336

(22) PCT Filed: Feb. 2, 2024
(86) PCT No.: PCT/EP2024/052617

§ 371 Date: Jul. 28, 2025

(30) Foreign Application Priority Data
Feb. 7, 2023 (EP) 23155401.5

(51) Int. Cl. H04W 72/1268; H04W 72/21

(52) U.S. Cl. CPC H04W 72/1268; H04W 72/21

(57) ABSTRACT

A method of operating a communications device for uplink transmission via a wireless radio interface is provided. The method includes operating in a configured grant (CG) mode by determining a plurality of periodic occasions of uplink communications resources, and transmitting signals during at least one of the periodic occasions. The method further includes transmitting uplink control information indicating which of a first occasion and one or more supplementary occasions associated with the first occasion are activated occasions for uplink data transmission. The communications device transmits uplink data during the indicated activated occasions. The first occasion and the supplementary occasions together form a set of periodic occasions of uplink communications resources.

### BACKGROUND

### Field of Disclosure

The present disclosure relates to communications devices, infrastructure equipment and methods for the more efficient operation of communications devices in wireless communications networks.

The present application claims the Paris Convention priority from European patent application number EP 23155401.5, filed on 7 Feb. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

One example of a new service is referred to as Ultra Reliable Low Latency Communications (URLLC) services which, as its name suggests, requires that a data unit or packet be communicated with a high reliability and with a low communications delay. Another example of a new service is extended Reality (XR), which may be provided by various user equipment such as wearable devices. XR combines real-world and virtual environments, incorporating aspects such as augmented reality (AR), mixed reality (MR), and virtual reality (VR), and thus requires high quality and minimised interaction delay. Services such as URLLC and XR therefore represent a challenging example for both LTE type communications systems and 5G/NR communications systems, as well as future generation communications systems. 5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

At least some embodiments of the present technique can provide a method of operating a communications device configured to transmit signals to a wireless communications network via a wireless radio interface. The method comprises operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface, transmitting, to the wireless communications network, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network, and transmitting the uplink data to the wireless communications network in the activated occasions. Here, the first occasion and the one or more supplementary occasions associated with the first occasion together form a single set of the plurality of periodic occasions of uplink communications resources.

At least some other embodiments of the present technique can provide a method of operating a communications device configured to transmit signals to a wireless communications network via a wireless radio interface. The method comprises operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface, determining that the communications device has uplink data to transmit to the wireless communications network, determining that the communications device is not able to transmit either the uplink data or uplink control information to the wireless communications network in a first occasion of the plurality of periodic occasions of uplink communications resources, and transmitting the uplink data to the wireless communications network in at least one of one or more supplementary occasions of the plurality of periodic occasions of uplink communications resources associated with the first occasion. Here, the first occasion and the one or more supplementary occasions associated with the first occasion together form a single set of the plurality of periodic occasions of uplink communications resources.

Such embodiments of the present technique, which, in addition to methods of operating communications devices, relate to methods of operating infrastructure equipment, communications devices and infrastructure equipment, circuitry for communications devices and infrastructure equipment, wireless communications systems, computer programs, and computer-readable storage mediums, can allow for the more efficient and effective use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of an NR-type wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4 is reproduced from [7], and illustrates a traffic model for extended Reality (XR);

FIG. 5 illustrates how different UEs can be assigned separate spatial-layer resources;

FIG. 6 illustrates how different UEs can be assigned separate frequency-domain resources;

FIG. 7 illustrates how different UEs can be assigned separate time-domain resources;

FIG. 8 shows an example of separate control and data resources within pre-assigned dedicated resources for a UE to perform UE-based scheduling techniques;

FIG. 9 illustrates an example of one periodic CG-PUSCH configuration comprising a single CG-PUSCH transmission occasion;

FIG. 10 illustrates an example of one periodic CG-PUSCH configuration comprising multiple CG-PUSCH transmission occasions

FIG. 11 shows a part schematic, part message flow diagram representation of a first wireless communications system comprising a communications device and an infrastructure equipment in accordance with embodiments of the present technique;

FIG. 12 illustrates an example where a data packet arrives at a UE's transmission buffer too late to be transmitted in a main CG-PUSCH occasion in accordance with embodiments of the present technique;

FIG. 13 illustrates an example where UCI may be attached to the end of a CG-PUSCH occasion in accordance with embodiments of the present technique;

FIG. 14 illustrates an example of how UCI can be used to indicate the used and unused CG-PUSCH occasions in one periodic CG-PUSCH occasion in accordance with embodiments of the present technique;

FIG. 15 shows a flow diagram illustrating a first example process of communications in a communications system in accordance with embodiments of the present technique;

FIG. 16 shows a part schematic, part message flow diagram representation of a second wireless communications system comprising a communications device and an infrastructure equipment in accordance with embodiments of the present technique;

FIG. 17 shows a flow diagram illustrating a second example process of communications in a communications system in accordance with embodiments of the present technique; and

FIG. 18 shows a flow diagram illustrating a third example process of communications in a communications system in accordance with embodiments of the present technique.

### DETAILED DESCRIPTION OF THE EMBODIMENTS

### Long Term Evolution Advanced Radio Access Technology (4G)

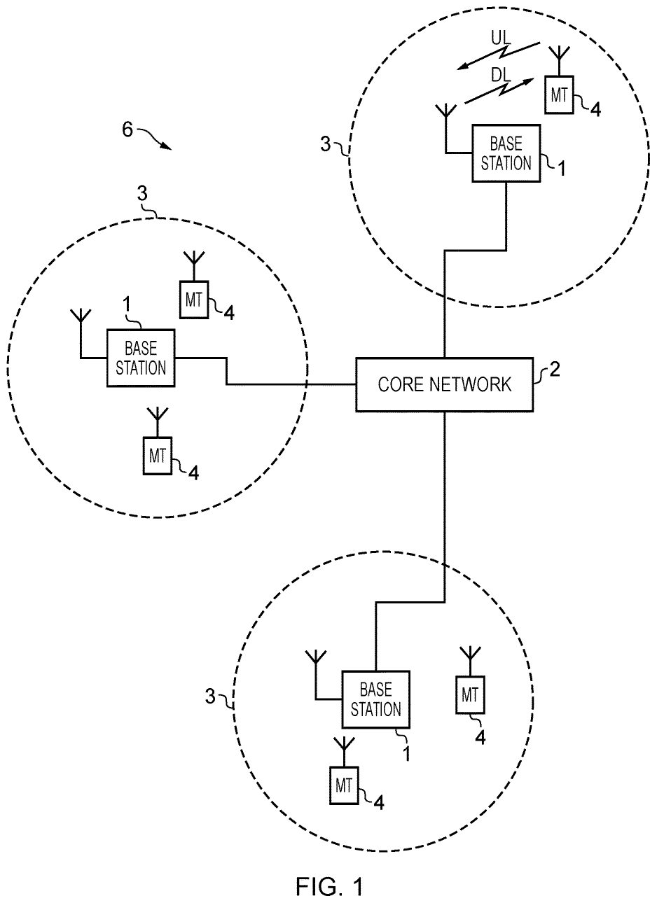

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

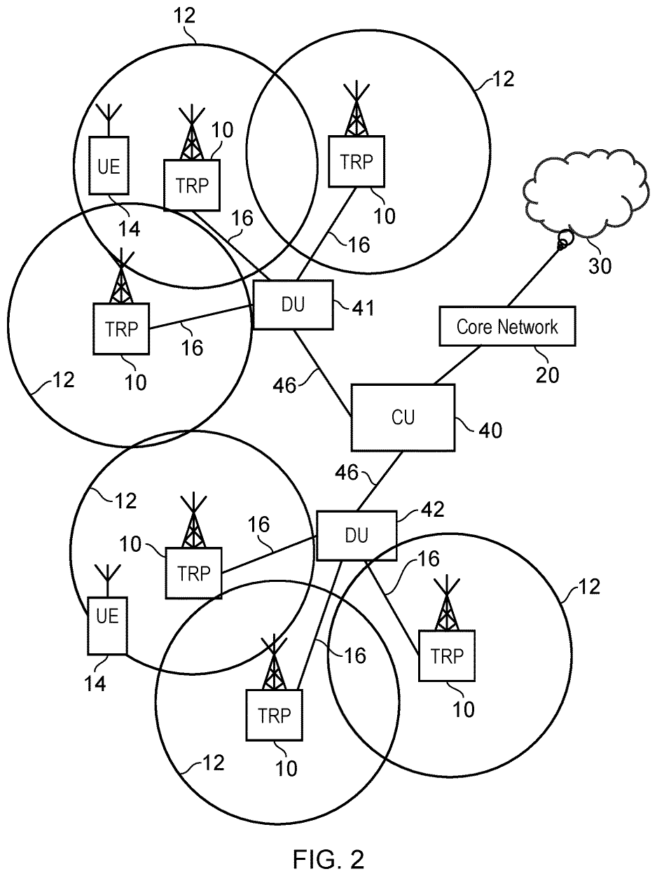

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

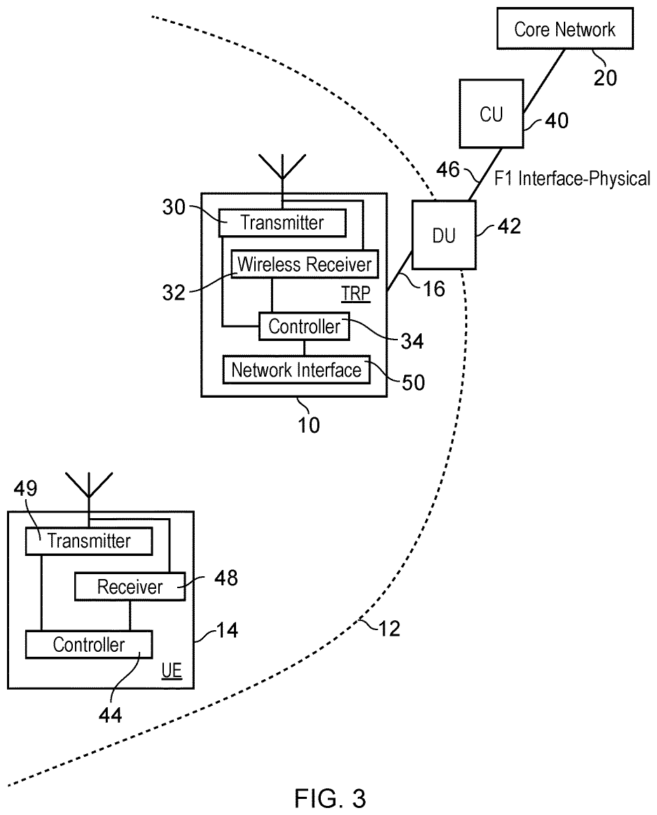

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

### Eurllc, NR-U, and eXtended Reality

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. A requirement for Ultra Reliable and Low Latency Communications (URLLC) services is that one transmission of a 32 byte packet is required to be transmitted from the radio protocol layer ⅔ SDU ingress point to the radio protocol layer ⅔ SDU egress point of the radio interface within 1 ms with a reliability of 1-10⁻⁵ (99.999 %) or higher (99.9999 %) [2]. Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning.

Enhanced URLLC (eURLLC) [3][4] specifies features that require high reliability and low latency, such as factory automation, transport industry, electrical power distribution, etc. It should be appreciated that the Uplink Control Information (UCI) for URLLC and eMBB will have different requirements. Another such service incorporating NR technology is 5G NR in Unlicensed Spectrum (NR-U) [5], which enable devices to make use of shared and unlicensed spectrum bandwidth. Such features as Listen Before Talk (LBT), as specified by [5], may be incorporated into the NR frame structure for NR-U operation in unlicensed bands.

eXtended Reality (XR) and Cloud Gaming refer to various types of augmented, virtual, and mixed environments, where human-to-machine and human-to-human communications are performed with the assistance of handheld and wearable end user devices (UEs). XR and Cloud Gaming are two more recently developed applications, that are considered important for NR Rel-18 and beyond (also known as 5G Advanced) [6].

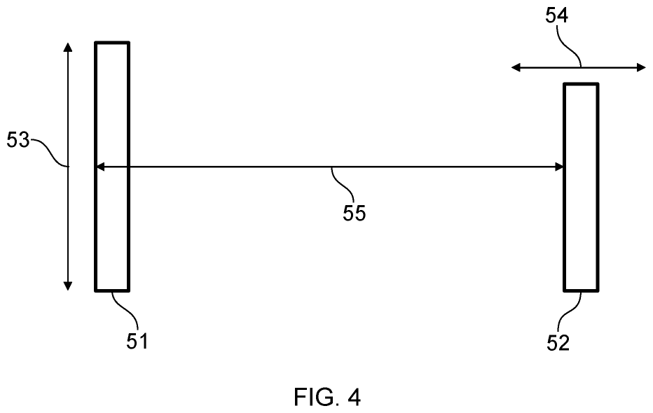

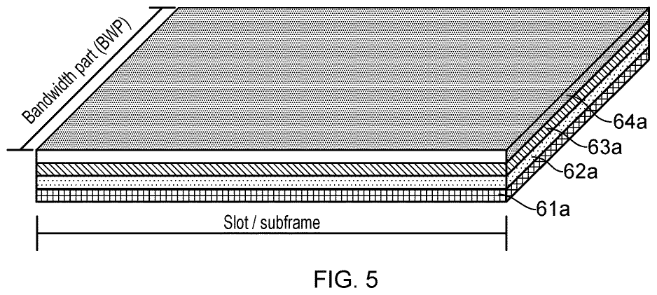

XR traffic is rich in video, especially in the downlink, with a typical frame rate of 60 Hz [7], which leads to a data transmission with non-integer periodicity in NR, i.e. the periodicity is not an integer number of subframes and in this example, the periodicity is 16.67 ms. Due to varying frame encoding delay and network transfer time, the packet arrival at the gNB may experience random jitter. The non-integer and jitter characteristics of XR traffic is known as quasi-periodic traffic. In addition to jitter, the packet size also varies within a range; that is the packet size in each period is random. The jitter and random packet size of UL traffic is illustrated in FIG. 4, which is based on a similar figure (FIG. 5.1.1-1) in [7].

FIG. 4 illustrates a single stream traffic model for XR. A first packet k 51 is transmitted, representing Internet Protocol (IP) packets belonging to video frame k. At a later point in time—which, on average, is the inverse of the frame generation rate (i.e. 1/fps) as denoted by arrow 55—a second packet k+1 52 is transmitted, representing IP packets belonging to video frame k+1. The variable packet size which follows a probability distribution is shown by arrow 53, while the variable jitter which also follows a probability distribution is denoted by arrow 54.

In the legacy 5G system, traffic with known periodicity and packet size, e.g. voice, is supported using Configured Grant PUSCH (CG-PUSCH) and Semi-Persistent Scheduling (SPS) Physical Downlink Shared Channels (PDSCH). In the legacy system, CG-PUSCH and SPS assume that the Transport Block Size (TBS) of the PUSCH and PDSCH of the traffic are the same in every period. However, in XR traffic, the payload of a quasi-periodic traffic may not be the same but varies within a range.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 2 and 3, where a significant number of additional features have been incorporated in different releases to provide new services and capabilities. Such services include eMBB, IIoT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide.

One of the areas for investigation for future mobile communications networks is uplink (UL) scheduling enhancements, which are expected to be required due to the increased number of services that require low latency communications and high reliability, as well as high throughput UL data transmissions from the terminal, like tactile internet, Audio-Video field production, and extended Reality (XR). In essence, it is proposed that a mobile terminal should be able to schedule unrestricted UL resources immediately after data arrives in its buffer for transmission, while taking into account the link adaptation parameters so that the transmissions are mostly ensured to be successful.

A typical use case (e.g. for broadcast TV production) is a camera transmitting a video stream using the User Data Protocol (UDP)/Internet Protocol (IP) protocol stack. In layer 2 of this protocol stack (L2), Radio Link Control-Unacknowledged Mode (RLC-UM) mode will be configured for UDP. Accordingly, dedicated (and probably regular) resources may be configured by the network, using techniques like periodic UL grant or configured grant. Such techniques are already developed and available.

As an example scenario, there might be a video algorithm which requires a camera not to transmit any uplink video frames if the view does not change. But as soon as the view changes, video codecs will have data available for transmission in L2 buffers. If traditional techniques are relied upon, the camera/UE must request UL resources before transmitting on the uplink. This involves additional signalling and latency, as the UE needs to request for scheduling, which is detrimental to live production. In this case, the UE waits an UL slot to send a Physical Uplink Control Channel (PUCCH) with a scheduling request (SR). The UE then waits for the network to schedule resources for the UE to use to transmit a limited amount of data, as the network does not know how much data is in the UE's buffer. Then, the UE is able to transmit this limited amount of data in the scheduled PUSCH in which it includes a Buffer Status Report (BSR), and waits to be scheduled resources for transmission of a larger amount of data (i.e. corresponding to that which it has in its buffer) based on the transmitted BSR information.

Further aspects of UL scheduling may be found in co-pending European patent application published under number EP3837895 [8], the contents of which are hereby incorporated by reference.

Some solutions for the above issue were presented in co-pending international patent application number PCT/EP2022/075108 [9], the contents of which are hereby incorporated by reference. Such solutions involve the exploitation of configured grant (CG) resources. The concept of UE-based scheduling as defined in [9] comprises a separate control part/resource (for UCI) and a separate data part/resource. The control part can be embedded onto the data part within a CG-PUSCH, or can be carried separately on a PUCCH whilst the data part is transmitted on a PUSCH.

### Legacy Scheduling Methods in NR (5G)

In cellular wireless communications, the channel between a mobile terminal and the base station typically experiences rapid and significant variations which impacts the quality of the received signal. In the small-scale variation, the channel goes through frequency selective fading which results in rapid and random variations in the channel attenuation. In the large-scale variation, there are shadowing and distance related path loss which affect the average received signal strength. In addition, there is interference arising from transmissions from nearby cells and terminals which distorts the signal at the receiver side.

In practice, the heart of mitigating and exploiting the variations of the channel condition is the scheduling mechanism that implements link adaptation algorithms, such as adaptive modulation and coding schemes (A-MCS), dynamic power control and channel-dependent scheduling.

In NR, the downlink and uplink multi-user schedulers are located at the base-station (gNB) where, in principle, the scheduler assigns the resources for the users with the best channel conditions in a given instance in both the UL and DL while taking into account the fairness among users as well. There are two types of scheduling mechanism, and these are termed as dynamic scheduling (or dynamic grant) and semi-persistent scheduling (or configured grant).

In dynamic multi-user scheduling for downlink transmissions, based on the instantaneous channel condition where the terminal feeds back the channel quality indicator (CQI) derived from downlink reference signals (RS) at regular time-intervals to the gNB, the scheduler at the gNB, after receiving the CQI, decides the best modulation and coding scheme (MCS), best “available” frequency resources (physical resource blocks (PRBs)) and adequate power for the downlink data transmissions for some users at a given subframe/slot. The downlink scheduling decisions, which are known as scheduling assignments, are carried by downlink control information (DCI), which is transmitted in the downlink to the scheduled users.

Similarly, for the dynamic multi-user scheduling for uplink transmission, based on the instantaneous channel condition where the terminal sends channel SRS at regular time-intervals to the gNB, the scheduler at the gNB, after deriving the CQI based on the last received SRS, decides the best modulation and coding scheme, best frequency resources (PRBs) for the uplink data transmissions from some users at a given subframe/slot. The uplink scheduling decisions, which are also known as scheduling assignments, are carried by downlink control information (DCI) which is transmitted in the downlink to the scheduled users.

For semi-persistent scheduling (SPS) however, the resources are pre-configured semi-statically (e.g. via radio resource control (RRC) signalling) with a certain periodicity, where this periodicity is aligned with the data arrival rate for a particular service. There is an SPS for the downlink (known as DL SPS) and an SPS for the uplink, which is referred to as configured grant (CG).

CG resources are mainly intended to deliver multiple traffic classes in a timely manner from the terminal, where such traffic classes have small data rates and some kind of periodicity, as specified in URLLC/IIOT in NR Rel-16/17. Some examples of the different traffic classes include industrial automation (future factory), energy power distribution, and intelligent transport systems, voice.

### Issues with Legacy Scheduling Methods

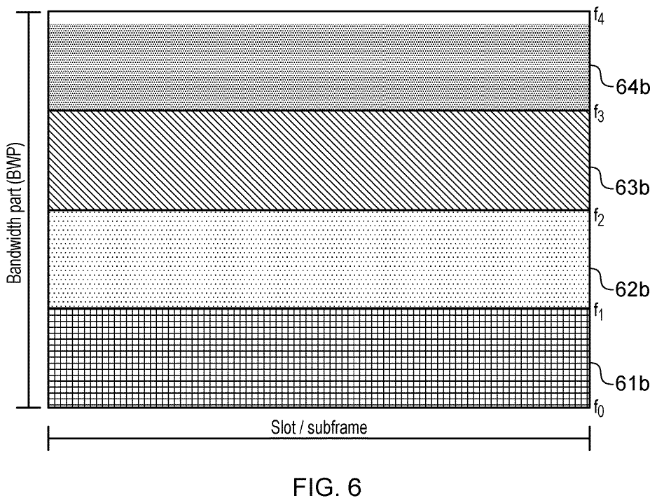

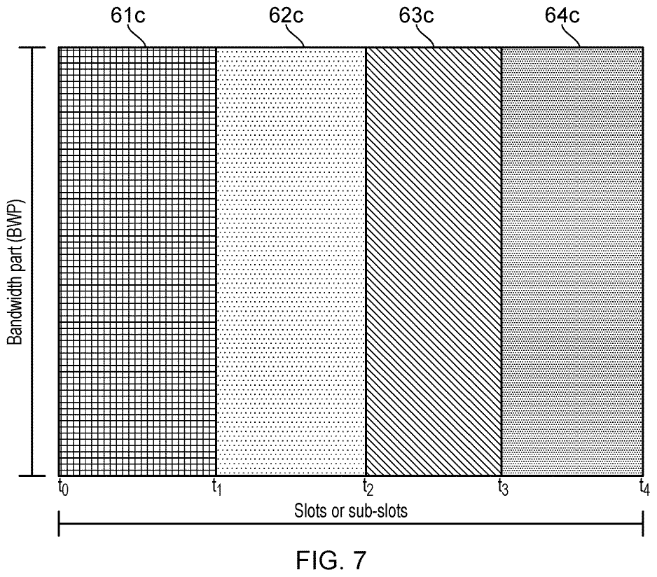

As described above, CG resources are mainly intended for traffic with a low data rate and with some kind of periodicity, as specified in URLLC/IIoT in NR Rel-16/17. However, for traffic with a high data rate and which requires low latency, larger resources would be needed. In this case, a UE can be pre-configured with dedicated larger resources for such uplink data transmissions. These resources can be allocated by one of the following methods (or by a combination of these methods):
Spatial-domain allocation: In this method, the gNB pre-allocates a specific spatial layer to the UE, where different UEs are allocated to different spatial layers in a bandwidth part (BWP), similar to multi-user multiple-input and multiple-output (MU-MIMO). This means that a UE has pre-allocated resources in the spatial-domain for both control and data. Hence, when the UE has data to transmit, the UE uses resources in the spatial layer reserved for it. The spatial-domain resource can be configured for a full set or a sub-set of BWP resources. As shown in the example in FIG. 5, a first UE may be assigned a first spatial layer 61a, a second UE may be assigned a second spatial layer 62a, a third UE may be assigned a third spatial layer 63a, and a fourth UE may be assigned a fourth spatial layer 64a;
Frequency-domain allocation: Similarly, to spatial-domain resources, dedicated frequency-domain resources can be pre-assigned to the UE where different UEs are allocated different frequency resources in a system bandwidth or a BWP. Hence, when data arrives at the UE's buffer, the UE uses the frequency resources allocated for it. As shown in the example in FIG. 6, a first UE may be assigned a first frequency resource set 61b (i.e. frequency range f₀-f₁), a second UE may assigned a second frequency resource set 62b (i.e. frequency range f₁-f₂), a third UE may assigned a third frequency resource set 63b (i.e. frequency range f₂-f₃), and a fourth UE may assigned a fourth frequency resource set 64b (i.e. frequency range f₃-f₄); and
Time-domain allocation: Similarly, to both spatial and frequency-domain resources, dedicated time-domain resources can be pre-allocated for a UE where different UEs are allocated different time resources (e.g. different sub-slots or slots) in a component carrier or BWP. As shown in the example in FIG. 7, a first UE may be assigned a first time resource set 61c (i.e. time range t₀-t₁), a second UE2 may be assigned a second time resource set 62c (i.e. time range t₁-t₂), a third UE may be assigned a third time resource set 63c (i.e. time range t₂-t₃), and a fourth UE may be assigned a fourth time resource set 64c (i.e. time range t₃-t₄).

An issue with using pre-configured dedicated resources for uplink data transmissions is that the resources are always reserved in advance, regardless of whether a UE actually has data to transmit or not. Even though a UE is able to release these pre-configured resources after finishing its UL data transmissions, the concern is that the signalling and commands for re-allocating/re-activating the resources will come from the network, which may result in some unbearable delays for a variety of services like Heavy uplink URLLC, and will also involve signalling from the UE to request resources either via a scheduling request (SR), or initiating a RACH procedure, or will involve resources being configured for idle periods.

Another issue with pre-configured resources is that a UE may not be able to control completely the link adaptation parameters, such as frequency-domain scheduling, in order to choose the best frequency resources (PRBs) in a BWP, modulation and coding scheme (MCS), etc. Since the UE has to wait, after sending its measurements and/or SRS to the network, for the network to determine such link adaptation parameters and signal these to the UE, which both introduces latency and means that the most appropriate parameters may not be selected as the channel conditions may have changed between the time that the UE performed the measurements and/or transmitted the SRS and the time that the UE receives the link adaptation parameters from the gNB.

Another issue with pre-configured resources is that a UE may have to use all the resources whenever it has data to transmit, because the gNB and UE must be synchronised for the allocated resources. This may mean that a UE must add padding bits in order to fill the remaining resources. This is clearly not desirable, as it increases the UE's power consumption unnecessarily, and also generates interference for other UEs located in the same cell or in neighbouring cells.

Accordingly, some enhancements for UL scheduling will be required for future mobile communications networks, such as 5G-Advanced and 6G . A set of requirements for such enhanced UL scheduling can be envisioned as listed below:
Immediate transmission of the UL data in order to reduce latency, for example for applications requiring heavy UL data with low latency;
Choosing appropriate link adaptation parameters, for example the best frequency resources (PRBs), MCS, power, etc.;
Flexible resource allocation scheme, for example frequency domain resource allocation (FDRA) and/or time domain resource allocation (TDRA);
An efficient way of identifying a UE and its resource allocation dynamically at the gNB receiver; and
Improving spectral efficiency of the cell, so that when a UE is not using its allocated resources, another UE could in principle be assigned such resources.

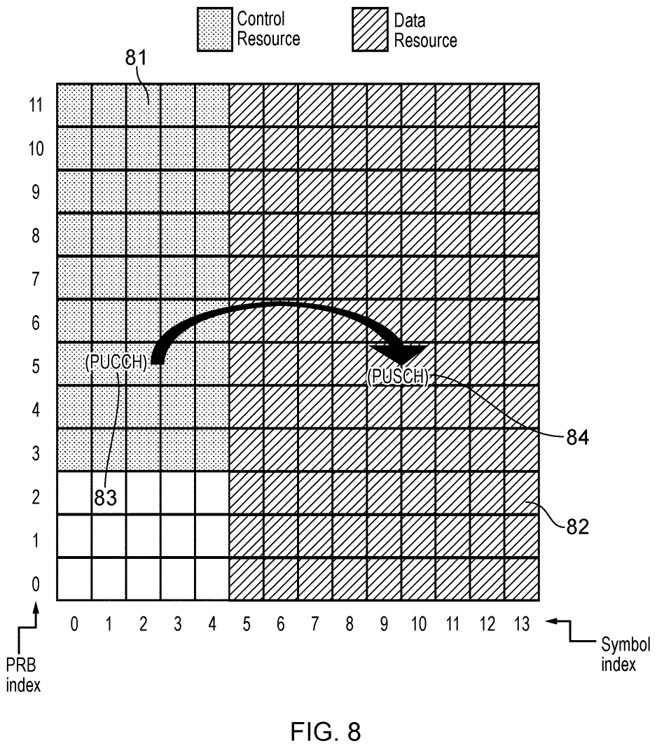

The solutions provided in [9], as noted above, relate to the support of UE-based scheduling, where a UE is pre-assigned CG resources for UL control and data transmissions in which the resources comprise UE-specific control resources and associated data resources. In an example of UE-based scheduling as shown in FIG. 8, the UE takes control of its own scheduling decisions (or assignments) for its UL data transmissions confined within the pre-configured CG resources. The UE-specific control resource is always available to the UE for scheduling the UL data on a specific BWP. It should be noted here that, based on current NR specifications, different data from up to 12 UEs (having different demodulation reference symbols (DMRS)) can be multiplexed onto the same resource in the spatial domain (i.e., MU-MIMO).

In UE-based scheduling techniques as described in [9] and shown by the example of FIG. 8, the PUCCH must be transmitted and placed before the data channel (PUSCH), so that the scheduling information and control signalling is decoded by the gNB before the PUSCH is received, in order to reduce the latency of decoding and buffering of the data channel. This is shown in FIG. 8, which shows an example of separate control resources 81 and data resources 82 within pre-assigned dedicated resources for a UE. If the gNB decodes the PUCCH 83 received within the control resources 81, but not the PUSCH 84 received within the data resources 82, the gNB will send a negative acknowledgement (NACK) to the UE. Otherwise, the gNB will transmit a positive acknowledgement (ACK) to the UE. A separate PUCCH may not be required in some cases, but instead, the scheduling information can be transmitted together with the PUSCH, such as in the form of a UCI in a CG-PUSCH.

Hence, [9] addressed the requirements for enhanced UL scheduling captured above, such as immediate UL data transmission, appropriate link adaptation, flexible resource allocation scheme, efficient way of identifying UE, and improving spectral efficiency of the cell.

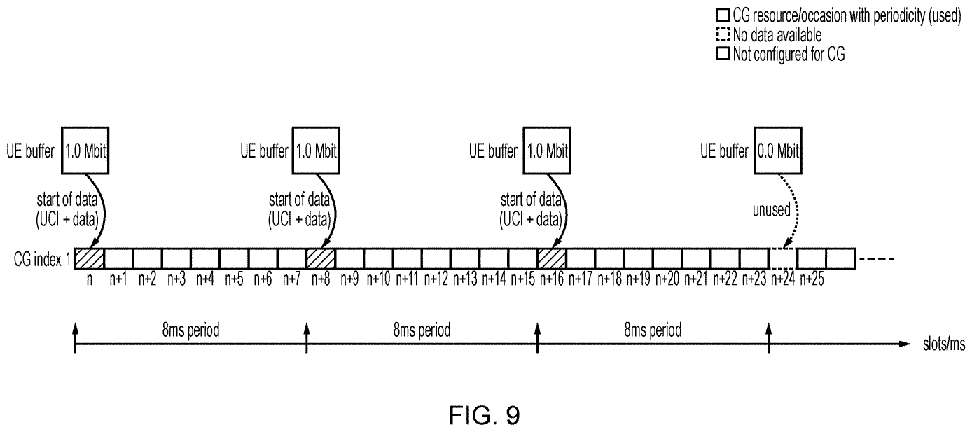

An example of a CG configuration is shown in FIG. 9, which is based on [9], where a periodic single CG occasion is configured, where the periodicity is eight slots (or 8 ms, assuming each slot has a period of 1 ms). In this example, it has been assumed that data is carried by a CG-PUSCH within a single CG occasion per configuration/set, where each CG-PUSCH has a TBS of 1 Mbit. If there is any remaining data (i.e. the data in a UE's transmit buffer is greater than this TBS of 1 Mbit), then such remaining data can be transmitted at the next occasion. In this case, Uplink Control Information (UCI) can also be transmitted within the PUSCH data to indicate whether the subsequent CG occasions are used/unused. In FIG. 9, at slot n, a UE begins transmission of new data on a CG-PUSCH and, because it does not transmit all of the data in that CG-PUSCH, also transmits a UCI. Here, this UCI indicates that there is still data to be transmitted at the next occasion in slot n+8, where the UE transmits further data along with a further UCI signalling that the UE still has further data to transmit. Subsequently, at slot n+16, the UE again transmits data on the CG-PUSCH and a UCI, where this time, the UCI indicates that the UE has no more data to transmit at the next occasion/slot n+24.

While such an arrangement as that shown in FIG. 9 allows a UE to have some control over the scheduling and transmissions of uplink data, there are issues with the configuration of only a single CG-PUSCH occasion in a CG period such as that shown in the example of FIG. 9, as is summarised below:
In a single CG occasion, the periodicity is generally always aligned with the arrival periodicity of new data. So, if all the data for applications such as XR is not transmitted within that single occasion, it will have to be delayed until the next occasion, in which further new data is supposed to be transmitted. Hence, this may cause some delays as data is built up in the UE's buffer over time. One solution to address so an issue could be to overprovision the periodicity of the CG occasions (i.e. reduce the number of slots between each CG occasion) in such a way that some of these CG occasions are used if necessary and some are not used. Though this would be likely to sufficiently address the issue of delay and data build-up in the UE's buffer, those skilled in the art would appreciate that XR data—as explained above with reference to FIG. 4—has different and variable characteristics. For example, the XR data may necessitate a heavy data transmission within a small period followed by a period of silence until new data arrives from the application layer. This means that much of the overprovisioned resources, particularly during the periods of silence or less heavy data arrival at the UE's buffers, would go unused, and so would lead to inefficient use of such resources which could otherwise be allocated to other UEs to transmit uplink data; and
There could be an application layer jitter at the UE, where the generation of the new data and its arrival in the UE's transmission buffer may become slightly shifted in time and thus cannot be delivered at the intended occasion. For example, with respect to XR applications, the jitter can shift the intended occasion within the range of +4 to −4 ms. Hence, if the periodicity (i.e. gap between CG-PUSCH occasions) is long, the data may sit in the UE's transmission buffer for a period that is longer than the XR delay budget. Hence, the data will be discarded at the end.

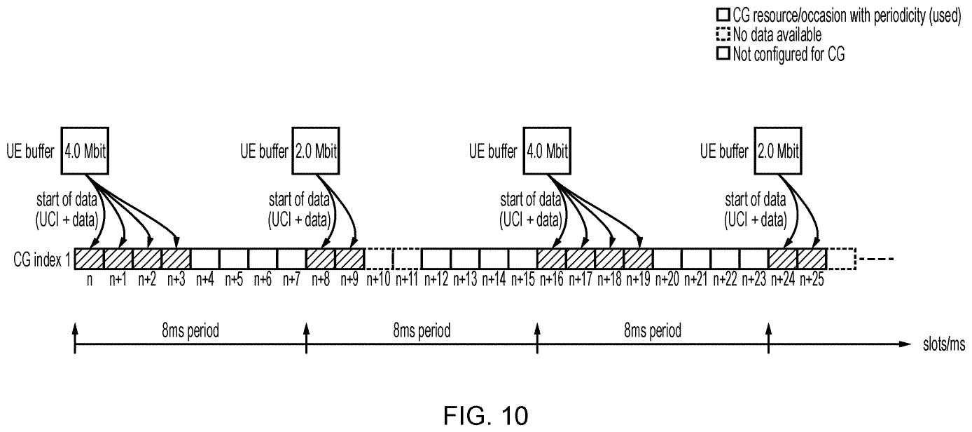

It has been agreed in [10] that for XR, multiple CG-PUSCH transmission occasions should be specified in a period of a single CG-PUSCH configuration and, dynamic indications of unused CG-PUSCH occasion(s) may be provided to the network within UCI transmitted by the UE. This means that whenever new data arrives at the UE's buffer/is generated by the UE, there is a number of dense/compact occasions available for the XR data to be transmitted within a specified period, so that the delay is minimised for PDU set transmission. The compact occasions here comprise one main occasion and one or more supplementary occasions associated with that main occasion. As shown in the example of FIG. 10, the periodicity of the main occasion may still be eight slots (or 8 ms, assuming each slot has a period of 1 ms), but in the overall period, a number of compact occasions are available for data transmission for applications such as XR, where it is likely that such occasions are concentrated within the leading slots of the period. The UCI then indicates which of these compact occasions are used for XR data transmission. However, while such solutions as those shown in [10] can address the problem of providing enough CG resources to transmit data (e.g. XR data) without such data building up in the UE's buffer, this still does not sufficiently address the issue of jitter, where XR data or the like may arrive at the UE's buffer after the start of the main occasion in a CG set, while the indication of the main/supplementary CG-PUSCH resources used is not always efficient. A technical problem to solve therefore is how to indicate efficiently which CG occasions within a period of a single CG configuration are used (or unused), and how to optimise the number of bits for doing so. Embodiments of the present technique define solutions to such a problem.

### Explicitly Indicated Used/unused CG Occasions in XR

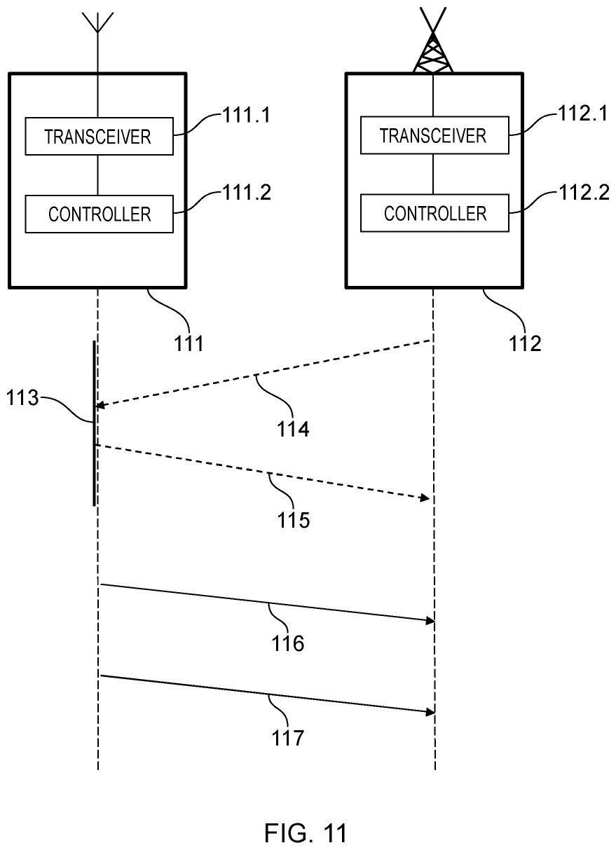

FIG. 11 shows a part schematic, part message flow diagram representation of a first wireless communications system comprising a communications device 111 and an infrastructure equipment 112 in accordance with at least some embodiments of the present technique. The communications device 111 is configured to transmit signals to and/or to receive signals from the wireless communications network, for example, to and from the infrastructure equipment 112. Specifically, the communications device 111 may be configured to transmit data to and/or receive data from the wireless communications network (e.g., to/from the infrastructure equipment 112) via a wireless radio interface provided by the wireless communications network (e.g., a Uu interface between the communications device 111 and the Radio Access Network (RAN), which includes the infrastructure equipment 112). Such data transmitted by the communications device 111 may, for example, include data for applications such as XR. The communications device 111 may be configured to transmit signals to and/or to receive signals from various other infrastructure equipment or communications devices not shown in the example of FIG. 11, while the infrastructure equipment 112 may also be configured to transmit signals to and/or to receive signals from various other communications devices or RAN or core network nodes not shown in the example of FIG. 11. The communications device 111 and the infrastructure equipment 112 each comprise a transceiver (or transceiver circuitry) 111.1, 112.1, and a controller (or controller circuitry) 111.2, 112.2. Each of the controllers 111.2, 112.2 may be, for example, a microprocessor, a CPU, or a dedicated chipset, etc.

As shown in the example of FIG. 11, the transceiver circuitry 111.1 and the controller circuitry 111.2 of the communications device 111 are configured in combination to operate 113 in accordance with a configured grant (CG) mode of operation, where the CG mode of operation may comprise the communications device 111 being configured to determine 114 (e.g. via an activation indication or other such command received from the wireless communications network, such as from infrastructure equipment 112) a plurality of periodic occasions of uplink communications resources (e.g. CG-PUSCH occasions) of the wireless access interface, and to (optionally) transmit 115 signals to the wireless communications network (for example, to the infrastructure equipment 112) in at least one occasion of the plurality of periodic occasions of uplink communications resources of the wireless access interface, to transmit 116, to the wireless communications network (e.g. to the infrastructure equipment 112), uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device 111 is to transmit uplink data to the wireless communications network (e.g. to the infrastructure equipment 112), and transmitting 117 the uplink data to the wireless communications network (e.g. to the infrastructure equipment 112) in the activated occasions. Here, the first occasion and the one or more supplementary occasions associated with the first occasion together form a single set of the plurality of periodic occasions of uplink communications resources.

The first occasion of uplink resource occasions as described with respect to the example of FIG. 11 above (and elsewhere in the description and claims), can be understood to be a main occasion or main CG-PUSCH, while the supplementary uplink resource occasions are supplementary CG-PUSCHs to that main CG-PUSCH. A single set of the plurality of periodic occasions therefore refers to one main CG-PUSCH and its associated supplementary CG-PUSCHs.

Essentially, such embodiments of the present technique propose that the UCI is able to indicate whether the main CG occasion is activated or not, and in addition, to indicate whether one or more of the supplementary CG occasions are independently activated. Here, the status (with respect to activation) of the supplementary CG occasions is not dependent on that of the main CG occasion with which they are associated; it is possible that a main CG occasion comprises no data transmitted by a UE but that one or more of its supplementary CG occasions do. This recognises that due to jittering, i.e. the quasi-periodic nature of traffic of applications such as XR for example, data packets may arrive at a time that is too late to be included in the main CG-PUSCH.

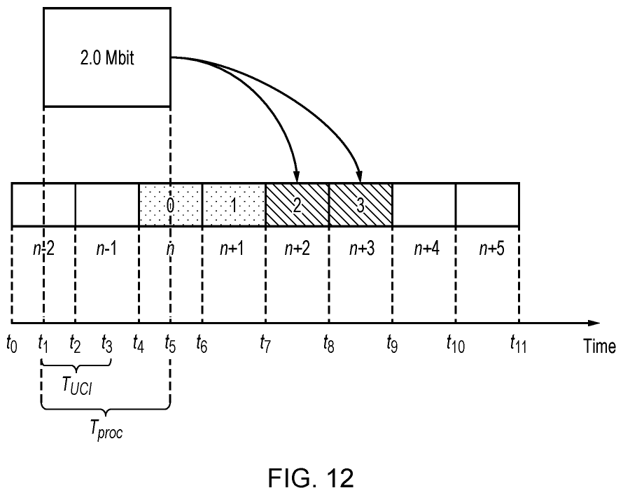

An example is shown in FIG. 12, where a CG-PUSCH set is configured with a main CG-PUSCH (labelled as “0”) and three supplementary CG-PUSCHs, labelled as “1”, “2”, and “3”. Here, it is assumed that the CG-PUSCH has a TBS of 1 Mbit. An XR packet arrives at time t₁, and it takes T_{proc} to process the packet into two 1 Mbit TBs. By the time the PUSCH TBs are processed at time t₅, it is too late to be transmitted into the main CG-PUSCH, which starts at time t₄. In the legacy Rel-16 NR-U, a CG-UCI is attached to a CG-PUSCH and if the CG-PUSCH is not transmitted, the CG-UCI is also not transmitted. Therefore, if such a legacy approach were applied here, the UE would transmit a dummy CG-PUSCH just so that it is also able to transmit the CG-UCI. Hence, it may be beneficial that the UE does not waste resources by using the main CG occasion to carry UCI to the gNB that the main CG occasion is not used. In the example of FIG. 12, the 2 Mbits XR packet is transmitted in supplementary CG-PUSCHs 2 and 3, and so the transmission of UCI indicating that the main CG-PUSCH and supplementary CG-PUSCH 1 are not used would enable these resources to be freed up for use by other UEs.

In some arrangements of embodiments of the present technique, the UCI is transmitted in a CG-PUSCH despite having no data in that CG-PUSCH. In other words, the uplink control information may be transmitted by the communications device in the first occasion (or one of the supplementary occasions) and indicates that the first (or supplementary) occasion carries only the uplink control information (and as such it is not one of the activated occasions (i.e. it does not contain any uplink data)) and that at least one of the supplementary occasions is among the activated occasions. Such arrangements recognise that the processing time required to generate a UCI (i.e. T_{UCI}) is shorter than the processing time required to generate a PUSCH, i.e. T_{UCI}<T_{Proc}. Hence, it is possible for the UE to attach a UCI to an empty CG-PUSCH (or on PUCCH) whilst still processing the PUSCH. Here, it should be understood by those skilled in the art that the activated occasions are those occasions which carry uplink data, and that occasions which are not activated occasions may therefore still carry UCI (though they do not carry uplink data). This is not to be confused with those occasions/CG-PUSCHs being active for use by the communications device, which of course applies to all of the first and supplementary occasions/CG-PUSCHs of a particular set.

Using the example in FIG. 12, the UE may not be able to process the PUSCH in time for main CG-PUSCH 0. However, it is able to process the UCI and transmit it in the main CG-PUSCH 0 but without any data, thereby informing the gNB that the main CG-PUSCH 0 and supplementary CG-PUSCH 1 are not activated and that the supplementary CG-PUSCH 2 and 3 are activated. This would mean that the gNB would be provided with the knowledge that no data is to be expected in the main CG-PUSCH or in supplementary CG-PUSCH 1, and hence it would not be required to monitor or blind-decode for such data. Here, the main CG-PUSCH 0 may occupy only a few OFDM symbols containing the UCI and leave the rest of the OFDM symbols empty since the UE has no data to transmit within the main CG-PUSCH.

In some arrangements of embodiments of the present technique, the UCI may be located at the start of the CG-PUSCH (i.e., the first few OFDM symbols). In other words, the uplink control information may be transmitted by the communications device at the start of either the first occasion or one of the supplementary occasions. This would therefore mean that the gNB is able to decode the UCI to determine whether or not any data is also carried within the CG-PUSCH carrying the UCI, without having to first blind decode for any such data (which may not actually have been transmitted) before receiving the UCI.

In some arrangements of embodiments of the present technique, the UCI is located at the end of a CG-PUSCH. In other words, the uplink control information may be transmitted by the communications device at the end of either the first occasion or one of the supplementary occasions. By locating the UCI at the end of the CG-PUSCH, additional time is allowed for the UE to process the UCI and transmit it in a CG-PUSCH occasion.

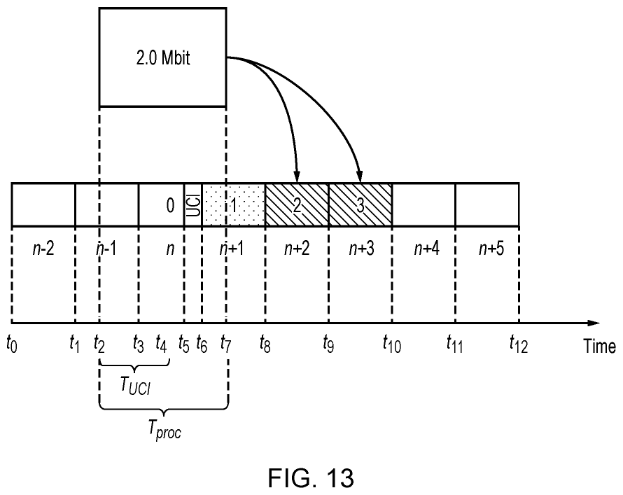

An example is shown in FIG. 13, where an XR packet arrives at the UE's transmission buffer at time t₂ and, after processing the corresponding PUSCHs at time t₇, it is too late to be transmitted in the main CG-PUSCH 0 or in supplementary CG-PUSCH 1. In this example, the UE was also not able to process the UCI prior to the start of the main CG-PUSCH 0 but, in accordance with such arrangements, the UCI is attached at the end of the main CG-PUSCH 0, thereby enabling the UE to transmit the UCI within the main CG-PUSCH 0 occasion. This therefore informs the gNB with respect to which supplementary CG-PUSCHs are activated before the gNB attempts to blind decode for data or UCI received within CG-PUSCH 1 (which is not activated). In this example, only supplementary CG-PUSCHs 2 and 3 are activated.

In some arrangements of embodiments of the present technique, the UE includes a bit pattern in the UCI that indicates whether the first/main occasion and or subsequent supplementary occasions are used or not in a period of a single CG configuration. In other words, the uplink control information may comprise a plurality of bits that indicate which of the first occasion and the supplementary occasions are among the activated occasions. Here, the meaning of the bit pattern in the UCI may be dependent on the occasion number/index of the CG-PUSCH which carries the UCI. In other words, the activated occasions which are indicated by the plurality of bits may be dependent on in which of the first occasion and the supplementary occasions the uplink control information is transmitted by the communications device.

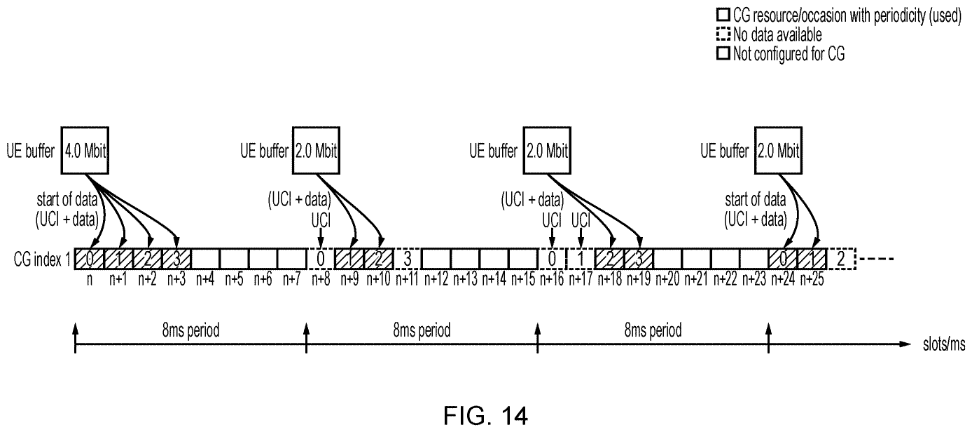

Firstly, it is proposed in view of such arrangements to introduce a numbering/indexing scheme for the compact occasions in a period/set, comprising the first/main occasion and supplementary occasions associated with that first/main occasion. For example, the compact occasions can contain either four or eight (or any suitable number of) occasions, depending on the expected data size (e.g. XR data size) in a PDU set. FIG. 14 shows an example where four occasions with numbering of 0, 1, 2, and 3 are used in a period of a single CG configuration. Secondly, it should be noted that the main purpose of having UCI transmitted to the gNB is to inform the gNB whether the future resources are used or not, so that the gNB can avoid wasted resources by assigning these resources to the other UEs, and in return, increase cell capacity as much as possible.

In some such arrangements of embodiments of the present technique, the UE may include such a bit pattern in the UCI transmitted within the first/main occasion that indicates whether the first/main occasion and subsequent supplementary occasions are used in a period of a single CG configuration and where the bit pattern in the UCI has a particular meaning to the UE and gNB based on it being transmitted within the first/main occasion. The UCI indicates whether or not there is data available for transmission on the main occasion, because in some cases as described above, there is some jitter from the application layer codec which may delay the XR data such that it cannot be transmitted within the main occasion, but can be transmitted within the supplementary occasions.

For example, as shown in FIG. 14, there are four compact occasions comprising the main occasion and three supplementary occasions which can be represented by 2-bits in the UCI as follows, for a UCI transmitted on the main occasion index 0:
00=no data is available is available on the first/main occasion with index 0 but data is available on the supplementary occasions with at least indexes 1 and 2: If data is not available on the main occasion at the time of encoding and transmitting of the UCI and the UE knows that there is data under process but that it is too late to carry such data on this CG-PUSCH occasion, the UE can include bit pattern “00” in the UCI. The main purpose of this is to inform the gNB to keep the resources reserved for the UE and hence monitor at least the UCI on the subsequent supplementary occasion indexes 1 and 2. It is here assumed that the UCI is separately encoded and transmitted (i.e. without any data being transmitted along with the UCI);
01=data is available on the main occasion and the supplementary occasion with index 1: If data is available for transmission on the main occasion and there is extra data under process that can occupy an additional occasion, the UE can include bit pattern “01” in the UCI;
10=data is available on the main occasion and the supplementary occasions with indexes 1 and 2: If data is available for transmission on the main occasion and there is extra data under process that can occupy an additional two occasions, the UE can include bit pattern “10” in the UCI; and
11=data is available on all allocated occasions, i.e. on the main occasion and all of the supplementary occasions with indexes 1, 2 and 3: If data is available for transmission on the main occasion and there is extra data under process that can occupy all three of the subsequent occasions, the UE can include bit pattern “11” in the UCI.

It should be appreciated by those skilled in the art that the above example does not restrict such arrangements of embodiments of the present technique to just the specific bit pattern (and meanings) and that other bit patterns with other meanings can be used; for example “11” can be used instead for “00” to indicate that main CG-PUSCH is not used but supplementary CG-PUSCH 1 and 2 may be used. It should also be noted that such arrangements (and indeed any arrangements of embodiments of the present technique as described herein) are not restricted to only a main CG-PUSCH and three supplementary PUSCHs, but can be expanded to other number of supplementary CG-PUSCHs. Likewise, the number of the plurality of bits in the bit pattern is of course not restricted to just two. Most examples described herein however relate to a main and three supplementary CG-PUSCH occasions (and to two bits in the bit pattern), but this is purely for ease of understanding and comparison, and not because the invention is intended to be limited in any such ways.

In other such arrangements of embodiments of the present technique, the UE may include such bit pattern in the UCI transmitted within one of the supplementary CG occasions that indicates whether the current and subsequent supplementary occasions are used in a period of a single CG configuration and where the bit pattern in the UCI has a particular meaning to the UE and gNB based on it being transmitted within that current supplementary occasion. The UCI indicates using this bit pattern whether there is any data available on the current occasion as well as on the subsequent supplementary occasions, if any. For example, for a UCI transmitted on the supplementary occasion index 1:
·00=no data is available on this occasion but available on other supplementary occasions with indexes 2 and 3: If data is not available on the occasion index 1 at the time of encoding and transmitting the UCI, and the UE knows that there is data under process, but it is too late to carry that data on this CG-PUSCH occasion, the UE can include bit pattern “00” in the UCI. It is assumed here that the UCI is separately encoded and transmitted;
01=data is available on this occasion and in the supplementary occasion with index 2: If data is available for transmission on the occasion index 1 and there is extra data under process that can occupy one more occasion, the UE can include bit pattern “01” in the UCI;
10= data is available on this occasion and the supplementary occasions with indexes 2 and 3: If data is available for transmission on the occasion index 1 and there is extra data under process that can occupy additional two occasions, the UE can include bit pattern “10” in the UCI; and
11=data is available on this occasion, and it is the last occasion for data transmission: If data is available for transmission on the occasion index 1 and there is no remaining data for transmission, the UE can include bit pattern “11” in the UCI.

For an example where UCI is transmitted on the supplementary occasion index 2:
00=no data is available on this occasion but available on the other (i.e. final) supplementary occasion with index 3: If data is not available on the occasion index 2 at the time of encoding and transmitting the UCI, and the UE knows that there is data under process, but it is too late to carry on this CG-PUSCH occasion, the UE can include bit pattern “00” in the UCI. It is assumed here that the UCI is separately encoded and transmitted;
01=data is available on this occasion and the supplementary occasion with index 3: If data is available for transmission on the occasion index 2 and there is extra data under process that can occupy one more occasion, the UE can include bit pattern “01” in the UCI.
10=no data available on this occasion: If data is not available on the occasion index 2 at the time of encoding and transmitting the UCI, the UE can include bit pattern “10” in the UCI. It is assumed here that the UCI is separately encoded and transmitted; and
11=data is available on this occasion, and it is the last occasion for data transmission: If data is available for transmission on the occasion index 2 and there is no remaining data for transmission, the UE can include bit pattern “11” in the UCI.

For an example where UCI is transmitted on the supplementary occasion index 3:
00=no data is available on this occasion: If data is not available on the occasion index 3 at the time of encoding and transmitting the UCI, the UE can include bit pattern “00” in the UCI. It is assumed here that the UCI is separately encoded and transmitted;

01=Reserved (since there are only two options here; data is transmitted on the final supplementary occasion with index 3, or it is not—the UE may transmit just a single bit in this case, i.e. 0 or 1, rather than a 2-bit indicator, in order to improve efficiency);
10=Reserved; and
11=data is available on this occasion, and it is the last occasion for data transmission: If data is available for transmission on the occasion index 3 and there is no remaining data for transmission, the UE can include bit pattern “11” in the UCI.

FIG. 14 can be used to illustrate how these (example) bit patterns described above may be applied. As shown in the specific example of FIG. 14, on the main occasion in the first period at slot n, the UE has data available for transmission (around 4 Mbit) and estimates that this data will occupy all four occasions with indexes 0, 1, 2, and 3 on slots n, n+1, n+2 and n+3 respectively. Hence, the UE includes bit pattern “11” which indicates that there is data available on the main occasion as well as all supplementary occasion indexes 1, 2 and 3. In the next period starting at slot n+8, the UE does not have data ready for transmission on the main occasion, but it knows that there is data under process, and therefore the UE can include bit pattern “00” in the UCI meaning that there will be data available soon and gNB should keep the resources reserved in the supplementary occasion indexes 1 and 2 on slots n+9 and n+10 respectively.

Similarly in the next period starting at slot n+16, the UE does not have data ready for transmission on the main occasion, but it knows that there is data to be processed and will take more time, the UE can include bit pattern “00” in the UCI meaning that there will be data available soon and the gNB should keep the resources reserved in the supplementary occasion indexes 1 and 2 on slots n+17 and n+18 respectively. However, it then may happen that the data is actually not ready yet for transmission within the supplementary occasion index 1 at slot n+17, and so UE can encode and transmit a further UCI separately that is dependent on supplementary occasion index 1. The UE therefore here includes bit pattern “00” in the UCI meaning that there will be data available soon and gNB should keep the resources reserved in the supplementary occasion indexes 2 and 3 on slots n+18 and n+19. Subsequently in the next period starting at slot n+24, on the main occasion, the UE has data available for transmission (around 2 Mbit) and estimates that data will occupy two occasions with indexes 0 and 1 on slots n+24 and n+25 respectively. Hence, the UE includes bit pattern “10” which indicates that there is data available on the main occasion as well as supplementary occasion index 1.

In some arrangements of embodiments of the present technique, contrary to the two-bit bit pattern described above, a bitmap of a size equal to the total number of supplementary CG-PUSCHs and the main CG-PUSCH is used to indicate (on a one-to-one basis) which CG-PUSCHs are activated. In other words, the number of the plurality of bits may be equal to the number of occasions of the uplink communications resources of the single set, and wherein each of the plurality of bits indicates whether a different one of the first occasion and the supplementary occasions is among the activated occasions. For example, in the case where a CG-PUSCH configuration has a main CG-PUSCH and three supplementary CG-PUSCHs, a bitmap of four bits can be used such that “1” indicates activated and “0” indicates not activated, i.e., an indication of say “1011” means main CG-PUSCH and the second and third supplementary CG-PUSCHs are activated, while the first supplementary CG-PUSCH is not activated.

In some arrangements of embodiments of the present technique, a bitmap equal to the size of the number of supplementary CG-PUSCHs are used to indicate (on a one-to-one basis) which supplementary CG-PUSCHs are activated or not. Here, the main CG-PUSCH is not included in the bitmap as the gNB would always monitor the main CG-PUSCH whether it is active or not, as per the legacy procedure, as so indicating its activation status would constitute a waste of resources. In other words, the number of the plurality of bits may be equal to the number of the supplementary occasions of the uplink communications resources, and wherein each of the plurality of bits indicates whether a different one of the supplementary occasions is among the activated occasions.

In some arrangements of embodiments of the present technique, a UE can transmit UCI on the supplementary occasions provided that the UE has already indicated in the previous occasions that there will be data/UCI transmission in this supplementary occasion. In other words, the communications device may be configured to transmit second uplink control information to the wireless communications network (e.g. to the infrastructure equipment) in at least one of the one or more supplementary occasions which is among the activated occasions. Here, this second uplink control information could indicate which subsequent supplementary CG-PUSCHs are active, if for example the main CG-PUSCH only indicated the current one in which the second UCI is transmitted, because for example the UE later determines that it requires more resources to transmit the uplink data in its transmission buffer.

In some arrangements of embodiments of the present technique, a UE attaches a cyclic redundancy check (CRC) checksum derived from the UCI bits/data in the UCI reporting (e.g., CRC of 8 bits) so that gNB can check if UCI is transmitted or not. In other words, the uplink control information may be transmitted by the communications device in either the first occasion or one of the supplementary occasions, wherein the first occasion or the one of the supplementary occasions in which the uplink control information is transmitted comprises a plurality of indication bits (that indicate the uplink control information itself) and a plurality of checksum bits which indicate the presence of the uplink control information (and thus ensure that the gNB perform unnecessary blind-decoding, whilst these checksum bits also enable the gNB to check whether the indication bits are correct).

In some arrangements of embodiments of the present technique, the used and unused subsequent supplementary occasions may be signalled by the UCI, but in an implicit manner. For example, the presence of other data transmission parameters in the UCI, like MCS, Resource allocations, etc. for a particular supplementary CG-PUSCH would indicate to the gNB that data is being scheduled for transmission in that supplementary CG-PUSCH, even if the UCI does not include an explicit indication that such a supplementary CG-PUSCH is activated. In other words, the uplink control information may indicate the activated occasions based on the uplink control information comprising an indication and/or values of one or more transmission parameters associated with each of the activated occasions.

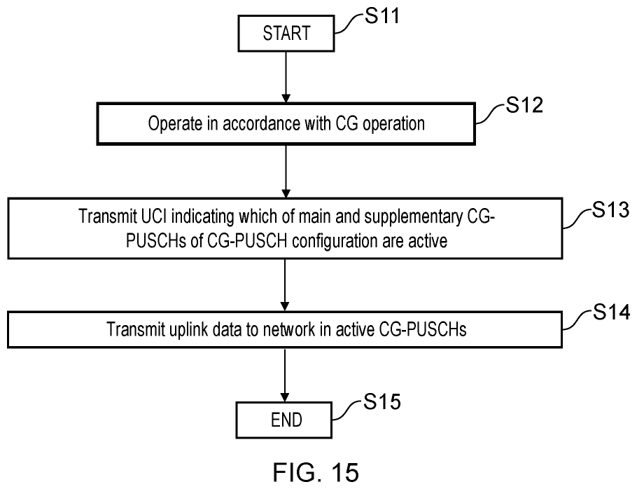

FIG. 15 shows a flow diagram illustrating a first example process of communications in a communications system in accordance with embodiments of the present technique. The process shown by FIG. 15 is a method of operating a communications device configured to transmit data to (and/or to receive data from) a wireless communications network (e.g. to an infrastructure equipment) via a wireless access interface (e.g. provided by the infrastructure equipment).

The method begins in step S11. The method comprises, in step S12, operating in accordance with a configured grant (CG) mode of operation. In step S13, the process involves transmitting, to the wireless communications network (e.g. to the infrastructure equipment), uplink control information indicating which of a first occasion of a plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network (e.g. to the infrastructure equipment). In step S14, the method comprises transmitting the uplink data to the wireless communications network (e.g. to the infrastructure equipment) in the activated occasions. Here, the first occasion and the one or more supplementary occasions associated with the first occasion together form a single set of the plurality of periodic occasions of uplink communications resources. The process ends in step S15.

### Implicitly Indicated Used/Unused CG Occasions in XR

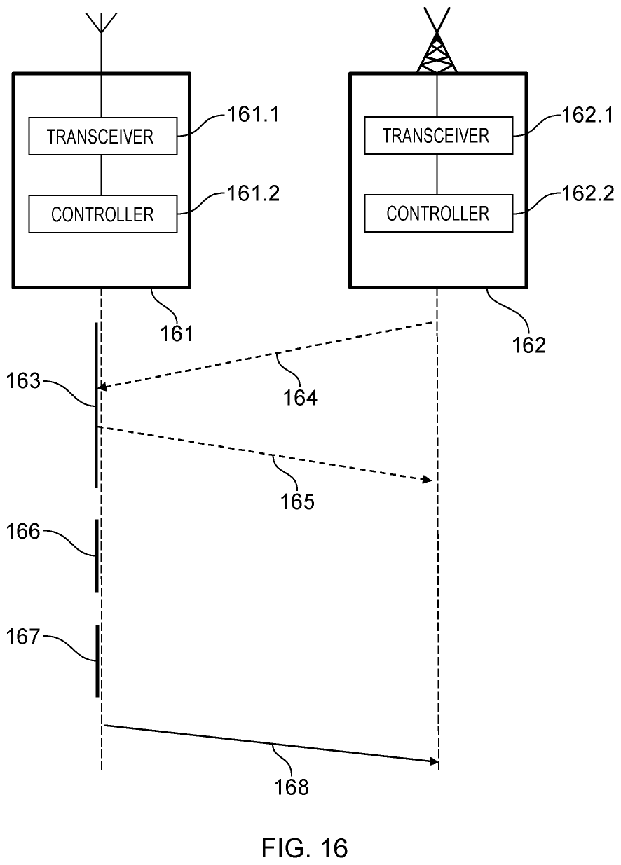

FIG. 16 shows a part schematic, part message flow diagram representation of a second wireless communications system comprising a communications device 161 and an infrastructure equipment 162 in accordance with at least some embodiments of the present technique. The communications device 161 is configured to transmit signals to and/or to receive signals from the wireless communications network, for example, to and from the infrastructure equipment 162. Specifically, the communications device 161 may be configured to transmit data to and/or receive data from the wireless communications network (e.g., to/from the infrastructure equipment 162) via a wireless radio interface provided by the wireless communications network (e.g., a Uu interface between the communications device 161 and the Radio Access Network (RAN), which includes the infrastructure equipment 162). Such data transmitted by the communications device 161 may, for example, include data for applications such as XR. The communications device 161 may be configured to transmit signals to and/or to receive signals from various other infrastructure equipment or communications devices not shown in the example of FIG. 16, while the infrastructure equipment 162 may also be configured to transmit signals to and/or to receive signals from various other communications devices or RAN or core network nodes not shown in the example of FIG. 16. The communications device 161 and the infrastructure equipment 162 each comprise a transceiver (or transceiver circuitry) 161.1, 162.1, and a controller (or controller circuitry) 161.2, 162.2. Each of the controllers 161.2, 162.2 may be, for example, a microprocessor, a CPU, or a dedicated chipset, etc.

As shown in the example of FIG. 16, the transceiver circuitry 161.1 and the controller circuitry 161.2 of the communications device 161 are configured in combination to operate 163 in accordance with a configured grant (CG) mode of operation, the CG mode of operation comprising the communications device 161 being configured to determine 164 (e.g. via an activation indication or other such command received from the wireless communications network, such as from infrastructure equipment 162) a plurality of periodic occasions of uplink communications resources (e.g. CG-PUSCH occasions) of the wireless access interface, and to (optionally) transmit 165 signals to the wireless communications network (for example, to the infrastructure equipment 162) in at least one occasion of the plurality of periodic occasions of uplink communications resources of the wireless access interface, to determine 166 that the communications device 161 has uplink data to transmit to the wireless communications network (e.g. to the infrastructure equipment 162), to determine 167 that the communications device 161 is not able to transmit either the uplink data or uplink control information to the wireless communications network (e.g. to the infrastructure equipment 162) in a first occasion of the plurality of periodic occasions of uplink communications resources, and to transmit 168 the uplink data to the wireless communications network (e.g. to the infrastructure equipment 162) in at least one of one or more supplementary occasions of the plurality of periodic occasions of uplink communications resources associated with the first occasion. Here, the first occasion and the one or more supplementary occasions associated with the first occasion together form a single set of the plurality of periodic occasions of uplink communications resources.

Essentially, such embodiments of the present technique propose that, the unused main CG occasion and/or supplementary CG occasion are implicitly indicated by the UE to the gNB. The said implicit indication is the absence of any transmission, and if the gNB did not detect any CG-PUSCH transmission when monitoring for one in a particular CG occasion, it assumes that that CG occasion is not used and thus proceeds to the next supplementary CG occasion where it does the same thing again. Using the example in FIG. 12, the gNB fails to detect any transmission in the main CG-PUSCH 0 and, instead of abandoning the entire CG-PUSCH occasion as would be the case in the legacy procedure (which includes the supplementary CG-PUSCHs), the gNB attempts to decode supplementary CG-PUSCH 1. Again, failing that, the gNB then attempts to decode supplementary CG-PUSCH 2, where here it does detect the transmission of data.

In some arrangements of embodiments of the present technique, the supplementary CG-PUSCH carries UCI to explicitly indicate whether subsequent CG-PUSCHs are activated or not. In other words, the communications device may be configured to transmit, to the wireless communications network (e.g. to the infrastructure equipment/gNB) in one of the one or more supplementary occasions, uplink control information indicating that the communications device is to transmit the uplink data to the wireless communications network in the at least one supplementary occasion (i.e. which include the CG-PUSCH occasion which carries the UCI and/or subsequent CG-PUSCHs). Using the example shown in FIG. 12, and assuming an implicit indication as described above with respect to the example system shown in FIG. 15, a UCI will be transmitted in CG-PUSCH 2 which indicates that CG-PUSCH 2 and CG-PUSCH 3 are activated. That is, a combination of implicit and explicit indications is used. This recognises that the UE may not have sufficient time to process a UCI to inform the gNB of the activation status of the CG-PUSCHs and, for this case, the gNB can use implicit indication, i.e., the absence of any CG-PUSCH including UCI to determine that that the CG-PUSCH is not used and to proceed with decoding the next (supplementary) CG-PUSCH. If the UE can process the UCI in time for transmission in a main or supplementary CG-PUSCH then this would save the gNB from having to blind decode unused CG-PUSCHs until it either detects the transmission of data or reaches the end of the set of CG occasions. As those skilled in the art would appreciate, the UCI transmitted here may take any format, such as for example, any format as described above (e.g. it is transmitted at the start or the end of the CG-PUSCH and may include a bit pattern, a bit map, and or a CRC checksum).

In some arrangements of embodiments of the present technique, if the UE is implemented or configured to transmit explicit indications only (and this is what the gNB expects to receive), then an absence of any data or UCI in the main CG-PUSCH would implicitly indicate to the gNB that the entire occasion, i.e., the main CG-PUSCH and all its associated supplementary CG-PUSCHs, are not activated. In other words, here, the infrastructure equipment/gNB may be configured to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface, to monitor for reception of uplink data and/or uplink control information in a first occasion of the plurality of periodic occasions of uplink communications resources, wherein the absence of uplink data and/or uplink control information in the first occasion indicates that no uplink data is to be received by the infrastructure equipment from the communications devices in any of one of one or more supplementary occasions of the plurality of periodic occasions of uplink communications resources associated with the first occasion. Here, the first occasion and the one or more supplementary occasions associated with the first occasion together form a single set of the plurality of periodic occasions of uplink communications resources.

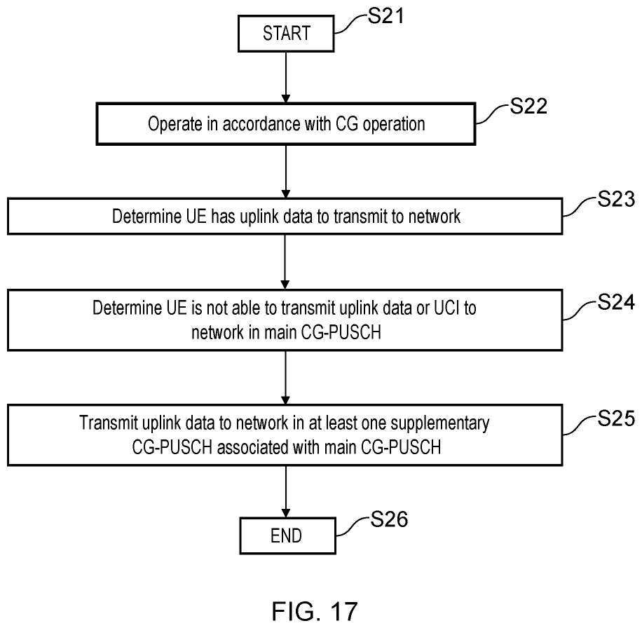

FIG. 17 shows a flow diagram illustrating a second example process of communications in a communications system in accordance with embodiments of the present technique. The process shown by FIG. 15 is a method of operating a communications device configured to transmit data to (and/or to receive data from) a wireless communications network (e.g. to an infrastructure equipment) via a wireless access interface (e.g. provided by the infrastructure equipment).

The method begins in step S21. The method comprises, in step S22, operating in accordance with a configured grant (CG) mode of operation. In step S23, the process involves determining that the communications device has uplink data to transmit to the wireless communications network (e.g. to the infrastructure equipment). In step S24, the method comprises determining that the communications device is not able to transmit either the uplink data or uplink control information to the wireless communications network (e.g. to the infrastructure equipment) in a first occasion of a plurality of periodic occasions of uplink communications resources. Then, in step S25, the method comprises transmitting the uplink data to the wireless communications network (e.g. to the infrastructure equipment) in at least one of one or more supplementary occasions of the plurality of periodic occasions of uplink communications resources associated with the first occasion. Here, the first occasion and the one or more supplementary occasions associated with the first occasion together form a single set of the plurality of periodic occasions of uplink communications resources. The process ends in step S26.

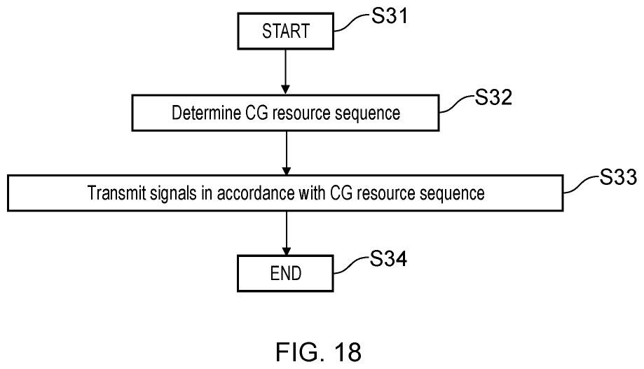

FIG. 18 shows a flow diagram illustrating a third example process of communications in a communications system in accordance with embodiments of the present technique. The process shown by FIG. 18 specifies more in-depth operation of a communications device operating in accordance with a configured grant (CG) mode of operation such as the CG mode of operation as referred to in step S12 of the method illustrated by FIG. 15 or step S22 of the method illustrated by FIG. 17.

The method begins in step S31. The method comprises, in step S32, determining a plurality of periodic occasions of uplink communications resources of a wireless access interface (e.g. through reception of an activation (or other) indication or a command defining such a plurality of periodic occasions from a wireless communications network, for example from an infrastructure equipment of the wireless communications network). In step S33, the method comprises, optionally, transmitting signals to the wireless communications network in at least one occasion of the plurality of periodic occasions of uplink communications resources of the wireless access interface. The process ends in step S34.

Those skilled in the art would appreciate that the methods shown by FIGS. 15, 17, and 18 may be adapted in accordance with embodiments of the present technique. For example, other intermediate steps may be included in such methods, or the steps may be performed in any logical order. Though embodiments of the present technique have been described largely by way of the example communications systems shown in FIGS. 11 and 16 (and further discussed with respect to the examples of FIGS. 12 to 14), it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a communications device configured to transmit signals to a wireless communications network via a wireless radio interface, the method comprising
operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface,
transmitting, to the wireless communications network, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network, and
transmitting the uplink data to the wireless communications network in the activated occasions, wherein the first occasion and the one or more supplementary occasions associated with the first occasion together form a single set of the plurality of periodic occasions of uplink communications resources.

Paragraph 2. A method according to Paragraph 1, wherein the uplink control information is transmitted by the communications device in the first occasion and indicates that the first occasion carries only the uplink control information and that at least one of the supplementary occasions is among the activated occasions.

Paragraph 3. A method according to Paragraph 1 or Paragraph 2, wherein the uplink control information is transmitted by the communications device at the start of either the first occasion or one of the supplementary occasions.

Paragraph 4. A method according to any of Paragraphs 1 to 3, wherein the uplink control information is transmitted by the communications device at the end of either the first occasion or one of the supplementary occasions.

Paragraph 5. A method according to any of Paragraphs 1 to 4, wherein the uplink control information comprises a plurality of bits that indicate which of the first occasion and the supplementary occasions are among the activated occasions.

Paragraph 6. A method according to Paragraph 5, wherein the activated occasions which are indicated by the plurality of bits are dependent on in which of the first occasion and/or the supplementary occasions the uplink control information is transmitted by the communications device.

Paragraph 7. A method according to Paragraph 5 or Paragraph 6, wherein the number of the plurality of bits is equal to the number of occasions of the uplink communications resources of the single set, and wherein each of the plurality of bits indicates whether a different one of the first occasion and the supplementary occasions is among the activated occasions.

Paragraph 8. A method according to any of Paragraphs 5 to 7, wherein the number of the plurality of bits is equal to the number of the supplementary occasions of the uplink communications resources, and wherein each of the plurality of bits indicates whether a different one of the supplementary occasions is among the activated occasions.

Paragraph 9. A method according to any of Paragraphs 1 to 8, comprising transmitting second uplink control information to the wireless communications network in at least one of the one or more supplementary occasions which is among the activated occasions.

Paragraph 10. A method according to any of Paragraphs 1 to 9, wherein the uplink control information is transmitted by the communications device in either the first occasion or one of the supplementary occasions, wherein the first occasion or the one of the supplementary occasions in which the uplink control information is transmitted comprises a plurality of indication bits and a plurality of checksum bits which indicate the presence of the uplink control information.

Paragraph 11. A method according to any of Paragraphs 1 to 10, wherein the uplink control information indicates the activated occasions based on the uplink control information comprising an indication and/or values of one or more transmission parameters associated with each of the activated occasions.

Paragraph 12. A communications device comprising transceiver circuitry configured to transmit signals to a wireless communications network via a wireless radio interface, and
controller circuitry configured in combination with the transceiver circuitry to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
to transmit, to the wireless communications network, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network, and
to transmit the uplink data to the wireless communications network in the activated occasions,
wherein the first occasion and the one or more supplementary occasions associated with the first occasion together form a single set of the plurality of periodic occasions of uplink communications resources.

Paragraph 13. Circuitry for a communications device comprising transceiver circuitry configured to transmit signals to a wireless communications network via a wireless radio interface, and
controller circuitry configured in combination with the transceiver circuitry to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
to transmit, to the wireless communications network, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network, and
to transmit the uplink data to the wireless communications network in the activated occasions,
wherein the first occasion and the one or more supplementary occasions associated with the first occasion together form a single set of the plurality of periodic occasions of uplink communications resources.

Paragraph 14. A method of operating an infrastructure equipment forming part of a wireless communications network, the infrastructure equipment being configured to receive signals from a communications device via a wireless radio interface provided by the infrastructure equipment, the method comprising
transmitting, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
receiving, from the communications device, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the infrastructure equipment is to receive uplink data from the communications device, and
receiving the uplink data from the communications device in the activated occasions,
wherein the first occasion and the one or more supplementary occasions associated with the first occasion together form a single set of the plurality of periodic occasions of uplink communications resources.

Paragraph 15. A method according to Paragraph 14, wherein the uplink control information is received by the infrastructure equipment in the first occasion and indicates that the first occasion carries only the uplink control information and that at least one of the supplementary occasions is among the activated occasions.

Paragraph 16. A method according to Paragraph 14 or Paragraph 15, wherein the uplink control information is received by the infrastructure equipment at the start of either the first occasion or one of the supplementary occasions.

Paragraph 17. A method according to any of Paragraphs 14 to 16, wherein the uplink control information is received by the infrastructure equipment at the end of either the first occasion or one of the supplementary occasions

Paragraph 18. A method according to any of Paragraphs 14 to 17, wherein the uplink control information comprises a plurality of bits that indicate which of the first occasion and the supplementary occasions are among the activated occasions.

Paragraph 19. A method according to Paragraph 18, wherein the activated occasions which are indicated by the plurality of bits are dependent on in which of the first occasion and the supplementary occasions the uplink control information is received by the infrastructure equipment.

Paragraph 20. A method according to Paragraph 18 or Paragraph 19, wherein the number of the plurality of bits is equal to the number of occasions of the uplink communications resources of the single set, and wherein each of the plurality of bits indicates whether a different one of the first occasion and the supplementary occasions is among the activated occasions.

Paragraph 21. A method according to any of Paragraphs 18 to 20, wherein the number of the plurality of bits is equal to the number of the supplementary occasions of the uplink communications resources, and wherein each of the plurality of bits indicates whether a different one of the supplementary occasions is among the activated occasions.

Paragraph 22. A method according to any of Paragraphs 14 to 21, comprising receiving second uplink control information from the communications device in at least one of the one or more supplementary occasions which is among the activated occasions.

Paragraph 23. A method according to any of Paragraphs 14 to 22, wherein the uplink control information is received by the infrastructure equipment in either the first occasion or one of the supplementary occasions, wherein the first occasion or the one of the supplementary occasions in which the uplink control information is received comprises a plurality of indication bits and a plurality of checksum bits which indicate the presence of the uplink control information.

Paragraph 24. A method according to any of Paragraphs 14 to 23, wherein the uplink control information indicates the activated occasions based on the uplink control information comprising an indication and/or values of one or more transmission parameters associated with each of the activated occasions

Paragraph 25. An infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to receive, from the communications device, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the infrastructure equipment is to receive uplink data from the communications device, and
to receive the uplink data from the communications device in the activated occasions, wherein the first occasion and the one or more supplementary occasions associated with the first occasion together form a single set of the plurality of periodic occasions of uplink communications resources.

Paragraph 26. Circuitry for an infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to receive, from the communications device, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the infrastructure equipment is to receive uplink data from the communications device, and
to receive the uplink data from the communications device in the activated occasions,
wherein the first occasion and the one or more supplementary occasions associated with the first occasion together form a single set of the plurality of periodic occasions of uplink communications resources.

Paragraph 27. A wireless communications system comprising a communications device according to Paragraph 12 and an infrastructure equipment according to Paragraph 25.

Paragraph 28. A method of operating a communications device configured to transmit signals to a wireless communications network via a wireless radio interface, the method comprising
operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface,
determining that the communications device has uplink data to transmit to the wireless communications network,
determining that the communications device is not able to transmit either the uplink data or uplink control information to the wireless communications network in a first occasion of the plurality of periodic occasions of uplink communications resources, and
transmitting the uplink data to the wireless communications network in at least one of one or more supplementary occasions of the plurality of periodic occasions of uplink communications resources associated with the first occasion,
wherein the first occasion and the one or more supplementary occasions associated with the first occasion together form a single set of the plurality of periodic occasions of uplink communications resources.

Paragraph 29. A method according to Paragraph 28, comprising
transmitting, to the wireless communications network in one of the one or more supplementary occasions, uplink control information indicating that the communications device is to transmit the uplink data to the wireless communications network in the at least one supplementary occasion.

Paragraph 30. A communications device comprising
transceiver circuitry configured to transmit signals to a wireless communications network via a wireless radio interface, and
controller circuitry configured in combination with the transceiver circuitry to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
to determine that the communications device has uplink data to transmit to the wireless communications network,
to determine that the communications device is not able to transmit either the uplink data or uplink control information to the wireless communications network in a first occasion of the plurality of periodic occasions of uplink communications resources, and
to transmit the uplink data to the wireless communications network in at least one of one or more supplementary occasions of the plurality of periodic occasions of uplink communications resources associated with the first occasion,
wherein the first occasion and the one or more supplementary occasions associated with the first occasion together form a single set of the plurality of periodic occasions of uplink communications resources.

Paragraph 31. Circuitry for a communications device comprising
transceiver circuitry configured to transmit signals to a wireless communications network via a wireless radio interface, and
controller circuitry configured in combination with the transceiver circuitry to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
to determine that the communications device has uplink data to transmit to the wireless communications network,
to determine that the communications device is not able to transmit either the uplink data or uplink control information to the wireless communications network in a first occasion of the plurality of periodic occasions of uplink communications resources, and
to transmit the uplink data to the wireless communications network in at least one of one or more supplementary occasions of the plurality of periodic occasions of uplink communications resources associated with the first occasion,
wherein the first occasion and the one or more supplementary occasions associated with the first occasion together form a single set of the plurality of periodic occasions of uplink communications resources.

Paragraph 32. A method of operating an infrastructure equipment forming part of a wireless communications network, the infrastructure equipment being configured to receive signals from a communications device via a wireless radio interface provided by the infrastructure equipment, the method comprising
transmitting, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
monitoring for reception of uplink data in a first occasion of the plurality of periodic occasions of uplink communications resources,
monitoring, if no uplink data is received in the first occasion, for reception of uplink data in one or more supplementary occasions of the plurality of periodic occasions of uplink communications resources associated with the first occasion, and
receiving uplink data from the communications device in at least one of the monitored supplementary occasions,
wherein the first occasion and the one or more supplementary occasions associated with the first occasion together form a single set of the plurality of periodic occasions of uplink communications resources.

Paragraph 33. A method according to Paragraph 32, comprising
receiving, from the communications device, in one of the one or more supplementary occasions, uplink control information indicating that the communications device is to transmit the uplink data to the infrastructure equipment in the at least one supplementary occasion.

Paragraph 34. An infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to monitor for reception of uplink data in a first occasion of the plurality of periodic occasions of uplink communications resources,
to monitor, if no uplink data is received in the first occasion, for reception of uplink data in one or more supplementary occasions of the plurality of periodic occasions of uplink communications resources associated with the first occasion, and
to receive uplink data from the communications device in at least one of the monitored supplementary occasions,
wherein the first occasion and the one or more supplementary occasions associated with the first occasion together form a single set of the plurality of periodic occasions of uplink communications resources.

Paragraph 35. Circuitry for an infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to monitor for reception of uplink data in a first occasion of the plurality of periodic occasions of uplink communications resources,
to monitor, if no uplink data is received in the first occasion for reception of uplink data in one or more supplementary occasions of the plurality of periodic occasions of uplink communications resources associated with the first occasion, and
to receive uplink data from the communications device in at least one of the monitored supplementary occasions,
wherein the first occasion and the one or more supplementary occasions associated with the first occasion together form a single set of the plurality of periodic occasions of uplink communications resources.

Paragraph 36. A wireless communications system comprising a communications device according to Paragraph 30 and an infrastructure equipment according to Paragraph 34.

Paragraph 37. A method of operating an infrastructure equipment forming part of a wireless communications network, the infrastructure equipment being configured to receive signals from a communications device via a wireless radio interface provided by the infrastructure equipment, the method comprising
transmitting, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
monitoring for reception of uplink data and/or uplink control information in a first occasion of the plurality of periodic occasions of uplink communications resources, wherein the absence of uplink data and/or uplink control information in the first occasion indicates that no uplink data is to be received by the infrastructure equipment from the communications devices in any of one of one or more supplementary occasions of the plurality of periodic occasions of uplink communications resources associated with the first occasion,
wherein the first occasion and the one or more supplementary occasions associated with the first occasion together form a single set of the plurality of periodic occasions of uplink communications resources.

Paragraph 38. An infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to monitor for reception of uplink data and/or uplink control information in a first occasion of the plurality of periodic occasions, wherein the absence of uplink data and/or uplink control information in the first occasion indicates that no uplink data is to be received by the infrastructure equipment from the communications devices in any of one of one or more supplementary occasions of the plurality of periodic occasions of uplink communications resources associated with the first occasion,
wherein the first occasion and the one or more supplementary occasions associated with the first occasion together form a single set of the plurality of periodic occasions of uplink communications resources.

Paragraph 39. Circuitry for an infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to monitor for reception of uplink data and/or uplink control information in a first occasion of the plurality of periodic occasions of uplink communications resources, wherein the absence of uplink data and/or uplink control information in the first occasion indicates that no uplink data is to be received by the infrastructure equipment from the communications devices in any of one of one or more supplementary occasions of the plurality of periodic occasions of uplink communications resources associated with the first occasion,
wherein the first occasion and the one or more supplementary occasions associated with the first occasion together form a single set of the plurality of periodic occasions of uplink communications resources.

Paragraph 40. A computer program comprising instructions which, when loaded onto a computer, cause the computer to perform a method according to any of Paragraphs 1 to 11, Paragraphs 14 to 24, Paragraph 28, Paragraph 29, Paragraph 32, Paragraph 33, or Paragraph 37.

Paragraph 41. A non-transitory computer-readable storage medium storing a computer program according to Paragraph 40.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors. Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.

[2] T R 38.913, “Study on Scenarios and Requirements for Next Generation Access Technologies (Release 14)”, third Generation Partnership Project, v14.3.0.

[3] R P-190726, “Physical layer enhancements for NR ultra-reliable and low latency communication (URLLC)”, Huawei, HiSilicon, RAN #83.

[4] R P-201310, “Revised WID: Enhanced Industrial Internet of Things (IoT) and ultra-reliable and low latency communication (URLLC) support for NR,” Nokia, Nokia Shanghai Bell, RAN #88e.

[5] R P-191575, “NR-based Access to Unlicensed Spectrum,” Qualcomm, RAN #84.

[6] R P-220285, “Revised SID: Study on XR Enhancements for NR”, Nokia, RAN #95e.

[7] T R 38.838, “Study on XR (Extended Reality) Evaluations for NR (Release 17)”, v 17.0.0.

[8] European patent application with publication number EP3837895.

[9] International patent application number PCT/EP2022/075108.

[10] R P-223502, “New WID on XR Enhancements for NR”, Nokia, Qualcomm, RAN #98-e.

1. A method of operating a communications device configured to transmit signals to a wireless communications network via a wireless radio interface, the method comprising
operating in accordance with a configured grant, CG, mode of operation, the CG mode of operation comprising determining a plurality of periodic occasions of uplink communications resources of the wireless access interface and transmitting signals to the wireless communications network in at least one occasion of the plurality of periodic occasions of uplink communications resources of the wireless access interface,
transmitting, to the wireless communications network, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network, and
transmitting the uplink data to the wireless communications network in the activated occasions,
wherein the first occasion and the one or more supplementary occasions associated with the first occasion together form a single set of the plurality of periodic occasions of uplink communications resources.

2. A method according to claim 1, wherein the uplink control information is transmitted by the communications device in the first occasion and indicates that the first occasion carries only the uplink control information and that at least one of the supplementary occasions is among the activated occasions.

3. A method according to claim 1, wherein the uplink control information is transmitted by the communications device at the start of either the first occasion or one of the supplementary occasions.

4. A method according to claim 1, wherein the uplink control information is transmitted by the communications device at the end of either the first occasion or one of the supplementary occasions.

5. A method according to claim 1, wherein the uplink control information comprises a plurality of bits that indicate which of the first occasion and the supplementary occasions are among the activated occasions.

6. A method according to claim 5, wherein the activated occasions which are indicated by the plurality of bits are dependent on in which of the first occasion and/or the supplementary occasions the uplink control information is transmitted by the communications device.

7. A method according to claim 5, wherein the number of the plurality of bits is equal to the number of occasions of the uplink communications resources of the single set, and wherein each of the plurality of bits indicates whether a different one of the first occasion and the supplementary occasions is among the activated occasions.

8. A method according to claim 5, wherein the number of the plurality of bits is equal to the number of the supplementary occasions of the uplink communications resources, and wherein each of the plurality of bits indicates whether a different one of the supplementary occasions is among the activated occasions.

9. A method according to claim 1, comprising
transmitting second uplink control information to the wireless communications network in at least one of the one or more supplementary occasions which is among the activated occasions.

10. A method according to claim 1, wherein the uplink control information is transmitted by the communications device in either the first occasion or one of the supplementary occasions, wherein the first occasion or the one of the supplementary occasions in which the uplink control information is transmitted comprises a plurality of indication bits and a plurality of checksum bits which indicate the presence of the uplink control information.

11. A method according to claim 1, wherein the uplink control information indicates the activated occasions based on the uplink control information comprising an indication and/or values of one or more transmission parameters associated with each of the activated occasions.

12. A communications device comprising
transceiver circuitry configured to transmit signals to a wireless communications network via a wireless radio interface, and
controller circuitry configured in combination with the transceiver circuitry
to operate in accordance with a configured grant, CG, mode of operation, the CG mode of operation comprising the communications device being configured to determine a plurality of periodic occasions of uplink communications resources of the wireless access interface and to transmit signals to the wireless communications network in at least one occasion of the plurality of periodic occasions of uplink communications resources of the wireless access interface,
to transmit, to the wireless communications network, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the communications device is to transmit uplink data to the wireless communications network, and
to transmit the uplink data to the wireless communications network in the activated occasions,
wherein the first occasion and the one or more supplementary occasions associated with the first occasion together form a single set of the plurality of periodic occasions of uplink communications resources.

13-24. (canceled)

25. An infrastructure equipment forming part of a wireless communications network, the infrastructure equipment comprising
transceiver circuitry configured to receive signals from a communications device via a wireless radio interface provided by the infrastructure equipment, and
controller circuitry configured in combination with the transceiver circuitry
to transmit, to the communications device, an indication that the communications device is configured to operate in accordance with a configured grant, CG, mode of operation, the CG mode of operation comprising, at the communications device, determining a plurality of periodic occasions of uplink communications resources of the wireless access interface and transmitting signals to the infrastructure equipment in at least one occasion of the plurality of periodic occasions of uplink communications resources of the wireless access interface,
to receive, from the communications device, uplink control information indicating which of a first occasion of the plurality of periodic occasions of uplink communications resources and one or more supplementary occasions of the plurality of periodic occasions of uplink communications resources associated with the first occasion are activated occasions of the plurality of periodic occasions of uplink communications resources in which the infrastructure equipment is to receive uplink data from the communications device, and
to receive the uplink data from the communications device in the activated occasions, wherein the first occasion and the one or more supplementary occasions associated with the first occasion together form a single set of the plurality of periodic occasions of uplink communications resources.

26-41. (canceled)
